(19) United States
(12) Patent Application Publication
(10) Pub. No.: US 2014/0289056 A1
(43) Pub. Date: Sep. 25, 2014

(54) CONSUMER-DRIVEN SOCIAL SHOPPING

(71) Applicants: Corbin Bernsen, Studio City, CA (US); Kendall Wouters, Chagrin Falls, OH (US); Andrew Maas, Canton, OH (US)

(72) Inventors: Corbin Bernsen, Studio City, CA (US); Kendall Wouters, Chagrin Falls, OH (US); Andrew Maas, Canton, OH (US)

(73) Assignee: POWSUMER, INC., Akron, OH (US)

(21) Appl. No.: 14/358,488

(22) PCT Filed: Nov. 16, 2012
(86) PCT No.: PCT/US2012/065517

§ 371 Date: May 15, 2014

Related U.S. Application Data
(60) Provisional application No. 61/560,558, filed on Nov. 16, 2011.

(51) Int. Cl. G06Q 30/02

(52) U.S. Cl. CPC G06Q 30/0276
USPC 705/14.72

(57) ABSTRACT

Systems and methods to facilitate discounted volume purchasing of a product. A server system searches the internet to discover product information about a product. The server system generates a pack listing of product type, purchase quantity, and price per unit product based on the discovered product information, and posts the pack listing on a web site of the server system. The server system further facilitates the activation of the pack listing by a user of the web site to generate a non-public pack. The server system also facilitates the commitment of a supplier to the non-public pack and the transformation of the non-public pack to a public pack. The server system further facilitates the filling of the public pack via the web site and various aspects of purchasing via the pack once the pack is filled by the requisite committed purchase quantity.

### CROSS REFERENCE TO RELATED APPLICATION

This application claims priority to and the benefit of U.S. Provisional Patent Application No. 61/560,558, filed on Nov. 16, 2011, and is incorporated herein by reference in its entirety.

### TECHNICAL FIELD

Certain embodiments relate to on-line shopping. More particularly, certain embodiments relate to systems and methods providing an on-line service for aggregating consumers (customers) and suppliers (e.g., retailers) to take advantage of discounted products and high volume sales and transactions at the consumer level.

### BACKGROUND

Today, consumers do more and more shopping for products on-line via the internet. Retailers or others that may be selling products to a consumer spend significant sums in attempting to draw consumers to buy products from them, including in advertising, but also by offering various sales, coupons, rebates, auctions and the like. Many times various sales, coupons, rebates, auctions and the like, are offered in relation to products. Further, such sales, coupons, rebates, auctions and the like are only offered to a consumer as an individual, and the consumer thus acts as an individual purchasing agent, and does not have the purchasing power that may come along with the ability to purchase a particular product in volume. An individual consumer doesn't need a product in volumes that would allow better discounts to be obtained. For example, if an individual consumer desires to purchase a particular brand and model of camera, that consumer will likely want to purchase one such camera for himself, or as a gift for another individual. However, if that individual consumer were, somehow, to be in the position to purchase fifty such cameras, they would be able to obtain volume discounts from a retailer or other product seller. It would be advantageous to provide the individual consumer with the ability to obtain volume discounts from a product seller.

There is also no current system that allows a consumer to directly control the discount that may be available, and to offer retailers or other sources of products to sell such products in a new manner. It would be desirable to provide the consumer with the power to dictate to the retailer or product seller the discounted price that they are willing to purchase the product for, putting the seller into the position of accepting an offer to purchase from a consumer.

There is also no current system that allows individual consumers to purchase products in bulk to afford the opportunity for a product seller to reduce inventory or meet other business needs. It would be worthwhile to provide a mechanism whereby a product seller could reduce inventory without resorting to services that attempt to liquidate inventory, taking a substantial cut of any proceeds.

### SUMMARY

According to an example, the present invention comprises a method to allow consumer driven sale of goods. In an aspect, the invention is directed to aggregating multiple consumers, each of who are interested in purchasing a particular product, into a purchasing pack in order to realize discounted prices of that product due to volume purchasing through the pack. In this manner, the consumer drives demand for a product and allows volume sales to be made by product suppliers. In this invention, a supplier may be a manufacturer, a wholesaler, a retailer, a reseller, an individual person, or any other entity capable of supplying a product to a consumer. This in turn allows the consumer to seek to buy the “hottest” or most popular, trending products in the marketplace, at a discounted price from retail. The product supplier generally does not have incentive to discount the hot, trending products, and generally such products are not offered at a discounted price. But, if there is the possibility of moving larger numbers of products, product suppliers can use this sales avenue to control and move inventory effectively. The product supplier may even benefit by allowing consumers to drive trends in product categories, driving demand for their products. The invention gains the advantage of allowing consumers to seek and buy prime, new products in high demand, and at a discounted price, by offering volume discounting. The sales process is a “consumer driven” inquiry, allowing effective control by the consumer.

In an example, a service provider (SP) provides a SP server system that scours the internet for information on a product and uses that information to define a pack listing for that product. The pack listing lists the particular product, purchase quantity, and price per unit product based on that purchase quantity at an on-line SP website. An individual originating consumer may go to the SP website and initiate activation of the pack posted on the website. As facilitated by the SP, one or more suppliers of the product may agree to commit to the pack by supplying the purchase quantity of the particular product at the listed price per unit. The SP, originating consumer, or supplier may help to get other consumers to join the pack to reach the purchase quantity to complete or fill the pack through, for example, social media. The SP server system further facilitates various aspects of purchasing via the pack once the pack is filled by the requisite committed purchase quantity. The invention relates to systems and methods that may be carried out by computer systems, but also applies to systems and methods without computer systems or servers.

The present invention also relates to systems and methods to mutually satisfy the consumer with a discount for the purchase of goods on the one hand, and the vendor with the ability to sell product in a different manner than currently practiced, and to reduce or control inventory. The invention brings together consumers into purchasing “packs” with social and web networks. The consumers have control to demand the lowest price from retailers, and are provided with alerts with real time market, product, and pricing trends. This allows retailers the ability to move excess inventory while providing consumers with the best price. In this manner, the system and methods meet the expectations of retailers and consumers alike. The system and methods also allow for gathering and quantifying information about product markets, consumer trends, and a wide variety of other information that is useful for both the consumer and retailer. This provides retailers and manufacturers a conduit to sell at profitable margins and at a price point that consumers feel is a good deal. In order for retailers and manufacturers to make this price point decision they need to have significant market input which may be aggregated and presented to the retailer/manufacturer/product source through a premium service and web-based tools. In implementation, the system and methods may be provided via a self service web site where consumers will be able to create and/or become involved in purchasing “packs” around specific products. Once complete the purchasing “pack” will be sent out to online/storefront retailers or other product sources requesting fulfillment of a large quantity of purchases at a reduced price. This provides a significant improvement for the consumer from traditional retail sales methods, and yet allows the product provider the ability to quickly and efficiently sell products. Retailers will also be presented with information with regard to price history, purchase trends, search trends, etc. in order to help the retailer to make a knowledgeable decision.

The present invention also provides a merchant with inexpensive or free advertising and marketing of the particular goods being offered for sale, utilizing the strength of a social network, along with a guarantee that the sale price will only have to be honored if a pack of consumers is created at the right price point. Accordingly, a merchant can provide a discount that matches their needs while satisfying the consumers desire to buy products at less than a retail price.

The invention also provides a mechanism to create value in serving as the transaction host for a sale. In an aspect of the invention, a sale is “effectively” made at the time that the consumer decides to create or join a pack and the pack is successful in being completed, allowing for money from the sale to be immediately (or soon thereafter) available for creating additional value before payment for the products is made to the seller. The offering of a pack purchase may remain available for a limited time to retailers or other sellers, for example, a number of days. In the event that a pack is not completed in a designated time, tools to facilitate the transaction may be employed, such as communication to consumers who have signed up for the pack and/or communication to retailers who have offered product for sale to the pack. Other techniques to facilitate the transaction may be employed, such as further discounting a given pack price as the number of actual customers and/or retailers increase. According to the present invention, a merchant or vendor is not selected for participation in discount retailing, but instead responds to consumer offers to purchase bulk products at a predetermined discounted price. The process is facilitated by aggregating consumers either through a global communication network, such as the Internet, or through some other vehicle that will be accessible to consumers, such as a cell phone, Intranet, email, Twitter or like message or another communication network. If the Internet is used, a website can provide the ability for a consumer to create and/or join a pack, to offer to buy a particular product at a discounted price set by the consumer. Sellers can then accept the offer to sell product to the pack participants. Social networking and other tools are provided to allow consumers to find other consumers to join a pack to make an offer to a seller and/or provide other information to support the process. Customers can sign up to receive an email when the deal is announced, and can access the system through one of the many social networking website systems, such as Facebook or Twitter. Other functions like communication via social networking website systems, such as Facebook or Twitter, may be provided based on the consumers own friends and contacts on such systems.

These and other novel features of the subject matter of the present application, as well as details of illustrated embodiments thereof, will be more fully understood from the following description and drawings.

### BRIEF DESCRIPTION OF THE DRAWINGS

FIG. 1 illustrates a block diagram of an example embodiment of a functional configuration of a system to aggregate multiple consumers into a purchasing pack in order to realize discounted prices for a product due to volume purchasing through the pack;

FIG. 2 illustrates a flow diagram of an example embodiment of a method to aggregate multiple consumers, who are interested in purchasing a particular product, into a purchasing pack in order to realize discounted prices of that product due to volume purchasing through the pack using the system of FIG. 1;

FIG. 3 illustrates an example embodiment of a pack table, provided by a website of the SP server system of FIG. 1, listing various product types along with pack quantity and purchase price per unit product based on the pack quantity; and

FIG. 4 illustrates a flow diagram of an example embodiment of a method to facilitate the filling of a pack using the system of FIG. 1.

### DETAILED DESCRIPTION

Embodiments of the present invention are directed to systems and methods to facilitate consumer-driven social shopping to take advantage of volume-based discounted prices on products. In the context of embodiments of the present invention, consumer-driven social shopping is accomplished at least in part over a communication network such as, for example, the internet.

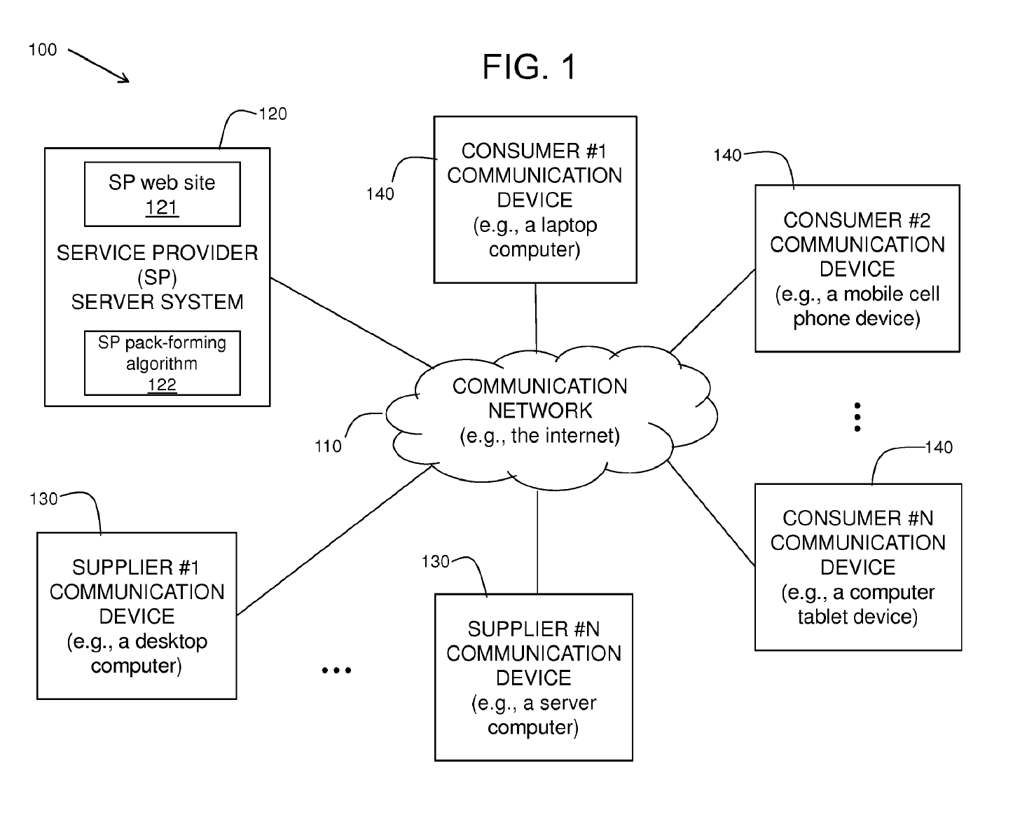

FIG. 1 illustrates a block diagram of an example embodiment of a functional configuration of a system 100 to aggregate multiple consumers into a purchasing pack in order to realize discounted prices for a product due to volume purchasing through the pack. The system 100 is an automated system that provides back and forth communication between consumers and suppliers using a service provider server system as a facilitating intermediary based on information aggregated from on-line communications.

The system 100 includes a communication network 110 such as, for example, the internet. However, other types of global communication networks are possible as well, in accordance with various other embodiments of the present invention. The communication network 110 may include various server computers, databases, and web sites providing product information on various types of products in which consumers may be interested. The system 100 also includes a service provider server system 120 provided by a service provider (SP) and configured to operatively communicate with the communication network 110. In general, the SP server system 120 facilitates the gathering and processing of product information, the formation of packs, and the logistics of purchasing and billing, as is described later herein.

The system 100 further includes one or more supplier communication devices 130 provided by one or more suppliers and configured to operatively communicate with the communication network 110 and corresponding to one or more suppliers (e.g., 1 to N). A supplier communication device 130 may be, for example, a desk top computer, a server computer, a mobile cell phone device, a computer tablet device, a laptop computer device, or any of other various types of communication devices cable of operatively communicating with the communication network 110. Such supplier communication devices 130 are used by suppliers of products as described later herein. A supplier may be a manufacturer, a wholesaler, a retailer, a reseller, an individual person, or any other entity capable of supplying a product to a consumer.

The system 100 also includes one or more consumer communication devices 140 provided by one or more consumers and configured to operatively communicate with the communication network 110 and corresponding to one or more consumers (e.g., 1 to N). A consumer communication device 140 may be, for example, a desk top computer, a mobile cell phone device, a computer tablet device, a laptop computer device, or any of other various types of communication devices cable of operatively communicating with the communication network 110. Such consumer communication devices 140 are used by consumers of products as described later herein. The terms “consumer” and “customer” are used interchangeably herein. A consumer is a person or entity interested in purchasing a product provided by a supplier.

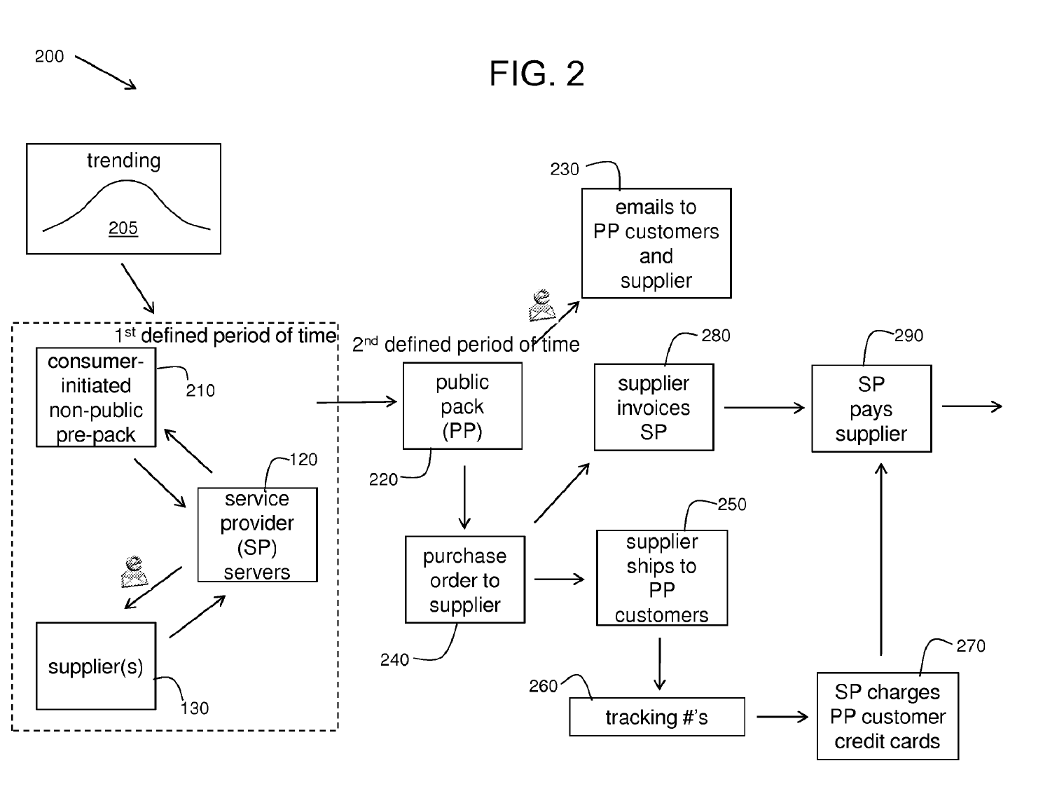

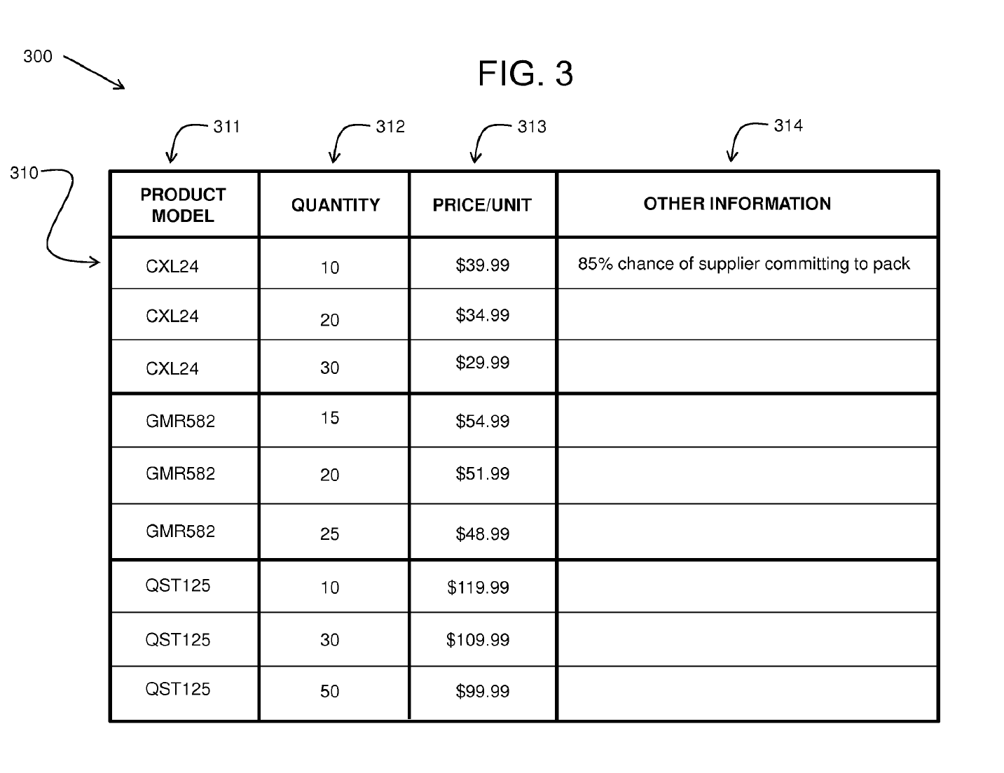

FIG. 2 illustrates a flow diagram of an example embodiment of a method 200 to aggregate multiple consumers, who are interested in purchasing a particular product, into a purchasing pack in order to realize discounted prices of that product due to volume purchasing through the pack using the system 100 of FIG. 1. At the start of the process, a consumer may access a web site 121 hosted on the SP server system 120 and observe a table which lists one or more pack listings. For example, FIG. 3 illustrates an example embodiment of a pack table 300, provided by the website 121 of the SP server system 120 of FIG. 1. The pack table 300 posts various potential pack offers or deals which list product types along with pack quantity and purchase price per unit product based on the pack quantity. In this example of the invention, a predetermined price can be arrived at by suitable volume discounting methods or models for example, such as an “all units” model, where the price of each unit is equal to the unit price for the cheapest volume tier reached. Alternatively, volume pricing information can be achieved based on the incremental model, package pricing approaches or other suitable models.

Other information about the product and listed pack may be available as well, in accordance with various embodiments of the present invention.

For example, referring to the first listed pack 310 in FIG. 3, the server system 120 has determined that product CXL24 (e.g., a particular camera) may be available for a unit discounted purchase price of $39.99 if a quantity of ten of the cameras are purchased together at the same time (i.e., in a pack). The SP server system 120 forms the pack table 300, in accordance with an embodiment of the present invention. Before forming the pack table 300, the SP server system 120 may search the communication network (e.g., the internet) 110 for product information. For example, the SP server system 120 may search the internet for information on cameras that may be available for purchase through various sources.

The server system 120 may have determined that the average single unit (non-volume) purchase price for product CXL24 is a predetermined price, such as $49.99 (based on information extracted from internet search results), but that one or more suppliers may be willing to discount the single unit price by $10.00 if a pack of ten can be guaranteed to be sold. Therefore, consumers who join the listed pack 310 can each potentially purchase the product for the discounted price of $39.99. The second listed pack, having a purchase quantity of twenty, allows consumers to potentially obtain the product (CXL24) for $34.99. The third listed pack, having a purchase quantity of thirty, allows consumers to potentially obtain the product (CXL24) for $29.99.

In accordance with an embodiment of the present invention, the SP server system 120 includes a SP pack-forming algorithm 122 that processes product information extracted from the internet to determine the details of a pack offer. For example, product information gathered from the internet may include trending data 205 (e.g., indicating which products have sales that are increasing, have peaked, are flat, or are tapering off), pricing data (low price point, high price point, historic pricing), supplier inventory data, estimations of margins, cost data vs. retail price, and product rating data. Other product information is possible as well. Details of the pack offer generated by the SP pack-forming algorithm 122 include specific product (make and model) 311, pack quantity 312, price per unit product 313, and other information 314 such as, for example, an estimate of the likelihood or probability that one or more suppliers will be willing to commit to the pack if the requisite quantity of consumers (pack quantity 312) are found (e.g., 85% likelihood). The probability of success of a pack may be determined by suitable algorithms taking into account any suitable factors and data as to volume pricing in a product category or relating to specific products.

Referring again to FIG. 2, once a pack listing is established, a consumer (or other user) may go to the web site 121 of the SP server system 120, view the details of the listed pack (e.g., 310), and activate the listed pack (e.g., by clicking on the listed pack) to initiate the generation of a non-public pack (i.e., a pre-pack) 210. Once a the pre-pack 210 is generated, a first a predetermined or defined period of time (e.g., 24 hours) is allotted during which the SP server system 120 communicates with potential suppliers (e.g., via email over the communication network 110) in an attempt to get one or more suppliers to commit to the pre-pack (i.e., agree to supply the quantity of the product at the discounted price). In accordance with an embodiment of the present invention, instead of a consumer activating the pack listing, a supplier may choose to activate or “seed” the pack listing 310 to initiate the pre-pack 210 in an attempt to generate sales of a product that the supplier has in stock.

The SP server system 120 includes stored information with respect to the product, suppliers, and quantity in stock and uses this information to determine which supplier(s) to approach with respect to the pre-pack 210. If no single supplier has the total quantity of the product as defined by the pack, the SP can attempt to aggregate two or more suppliers within the first defined time period to try to fill the pack, for example, in a similar manner in which consumers are aggregated in a pack. In such a scenario, the SP server system 120 handles multiple suppliers and assigns consumers to suppliers.

The SP may also provide trending data 205 to a supplier in an attempt to convince a supplier that the supplier should aggregate with other suppliers through the SP to sell their products. For example, the SP may provide one level of trending data to a supplier for free, and may offer to supply a higher level of trending data to a supplier for a fee, in accordance with an embodiment of the present invention. The SP may also provide other consumer intelligence data and associated data analysis to a supplier for a fee.

If no suppliers commit to the terms of the pre-pack 210 within the first defined period of time, then the SP service system 120 notifies the initiating consumer (e.g., via email over the communication network 110) that the pre-pack was not committed, and the pre-pack is discontinued. As an alternative, a supplier may respond to the service provider (SP) by suggesting alternative terms (product, quantity, price) of the pre-pack. For example, a supplier may suggest to lower the discounted price because the supplier has a large inventory of the product. In such a scenario, the SP can go back to the initiating consumer and request that the pre-pack be modified accordingly. In this way, suppliers may bid or compete with each other for the pack business.

As another alternative, if the pack doesn't get filled within the first defined period of time, then the SP may initiate a back and forth on-line negotiation between the SP and the supplier in an attempt to get the supplier to agree to the current number of products committed to by consumers in the pack at the same or higher price, for example. If the supplier agrees to the new proposed terms, the SP can go back to the consumers and determine if the new proposed terms are acceptable (e.g., if the committed consumers will agree to the higher price).

As a further alternative, if a supplier doesn't have the required quantity of the product but has the required quantity of a similar but different product (e.g., last year's model), the supplier can recommend to the SP to change the terms of the pack to supply the similar but different product, for example, at a lower price. The SP can then go to the consumers and determine if the new proposed terms are acceptable. In effect, the system 100 acts as an automated intermediary that provides back and forth communication between consumers and suppliers using the SP server system 120 based on information aggregated from the internet.

Once a supplier (or a group of suppliers) agrees to commit to the terms of the pre-pack 210 within the first defined period of time (e.g., 24 hours), then the pre-pack 210 is converted to a pre-authorized public pack 220 which is posted on the SP web site 121 for public viewing (i.e., the pack goes live on the SP web site), and the associated parties (initiating consumer and suppliers) are notified through the communication network 110. A second defined period of time (e.g., 72 hours) is established during which the public pack 220 is open and is to be filled (i.e., there is a limited time to get the requisite number of other consumers to commit to the public pack). For example, the initiating consumer is already committed to purchasing one camera via the public pack 220. However, other consumers need to commit to purchasing the nine other cameras via the public pack 220 within the second defined period of time in order for the actual sale of all ten cameras to take place.

The initiating consumer of the pack, the SP, and/or the committed supplier(s) may next take steps to help fill the public pack 220. For example, the SP can advertise the public pack 220 on the SP web site 121. The initiating consumer may use contacts on social network sites to alert other potential consumers to the public pack 220 and direct the other potential consumers to the SP web site 121. Furthermore, a supplier may choose to advertise the public pack 220 on their supplier web site and direct potential consumers to the public pack 220 on the SP web site 121. In general, anyone can search on-line for the product (e.g., the CXL24 camera) corresponding to the public pack 220 to find the public pack 220 on the SP web site 121.

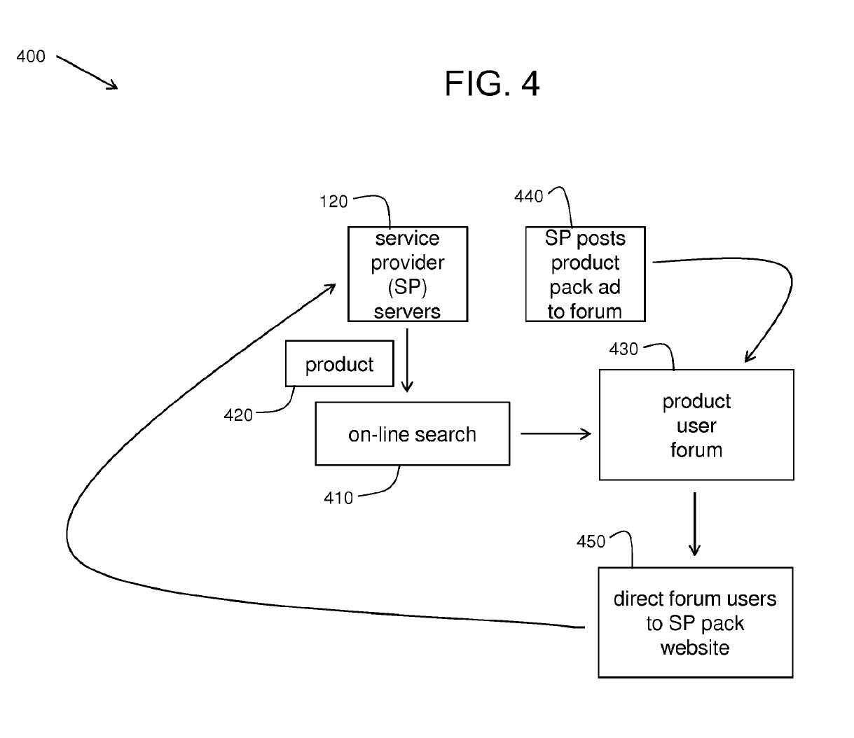

FIG. 4 illustrates a flow diagram of an example embodiment of a method 400 to facilitate the filling of a public pack using the system 100 of FIG. 1. In the example method 400, the SP performs an on-line search 410 of a product category 420 related to the public pack 220 (e.g., the CXL24 camera product category) on the internet 110 via the SP server system 120. The on-line search 410 discovers an on-line product user forum 430 where users of the product related to the public pack 220 share comments and information about their experiences with the product. Since the product user forum 430 naturally attracts people specifically interested in the product related to the public pack 220, the SP may post an advertisement 440 of the public pack 220 on the forum 430. The posting of the advertisement 440 makes users aware of the existence of the public pack 220 and can provide direction 450 for the forum users to the SP web site 121 where the public pack 220 can be found, for example, when a user may be interested in joining the pack 220. The method 400 is one way of facilitating the filling of the public pack 220 within the second defined period of time (e.g., 72 hours). In accordance with various embodiments of the present invention, other social networking venues may be used to make potential consumers aware of a public pack.

The invention may also provide for dynamic advertising to let potential new pack members know of currently open packs when they are created and while they are open. For example, when a pack is created or open, the SP may provide a stream of information to an online advertising agency. The advertising agency can then create an online advertisement, a dynamic advertisement, that will be communicated to various sources. Such as advertisement may be shown when a person searches for a product for which an open pack exists, such as on Google or other search engine. The advertisement could also be sent to past users/consumers, or many other sources to get the word out on the existence of the open packs looking for additional pack members. The present invention thus provides a merchant with inexpensive or free advertising and marketing of the particular goods being offered for sale, utilizing the strength of a social network, online advertising and other tools, along with a guarantee that the sale price will only have to be honored if a pack of consumers is created at the right price point. Accordingly, a merchant can provide a discount that matches their needs while satisfying the consumers desire to buy products at less than a retail price.

Prospective pack joiners are provided with all of the product and pack information at the SP website 121, allowing them to make a decision about joining the public pack 220. When a consumer wants to join the public pack 220, the consumer selects the public pack 220 via the web site 121 (e.g., by clicking on an icon of the public pack). The consumer can select the public pack 220 multiple times to purchase a corresponding multiple number of the product from the public pack 220. For example, if a consumer wants to purchase three cameras from the pack 220, the consumer can enter a quantity of three. When a consumer joins the pack, the consumer is instructed to provide credit card information, shipping information, and a user name. Other information may be required as well, in accordance with various embodiments of the present invention. A hold is put on the credit card purchase for the time being.

In accordance with an alternative embodiment of the present invention, a public pack can be a dynamic public pack that includes dynamic pricing. For example, each time a consumer joins the dynamic public pack, the price per unit of the product is discounted further for all joining consumers. Such a dynamic public pack may induce potential consumers to join the pack and to try to get others to join the pack. The dynamic public pack has the potential to reach a lowest possible discounted price per unit if the pack gets filled. In this example, sliding pricing may be provided based on market factors, with higher volumes triggering further reduced pricing to benefit both the product supplier and consumer.

Once the public pack 220 is filled (i.e., once the purchase of all ten cameras are committed to), the pack closes. No one else can join the pack since the supplier has committed to only supplying the number of products defined by the pack (e.g., ten CXL24 cameras). Communications 230 (e.g., emails) are provided to the consumers and supplier(s) committed to the pack indicating that the pack has been filled and that the sales transactions of the product can proceed.

As another alternative, if the pack doesn't get filled within the second defined period of time, then the SP may initiate a back and forth on-line negotiation between the SP and the supplier in an attempt to get the supplier to agree to the current number of products committed to by consumers in the pack at the same or higher price, for example. If the supplier agrees to the new proposed terms, the SP can go back to the consumers and determine if the new proposed terms are acceptable (e.g., if the committed consumers will agree to the higher price). Alternatively, a committed consumer could make a further offer that is communicated to the supplier for example. It is also possible that even after the public pack 220 is filled (i.e., once the purchase of all ten cameras are committed to), the pack closes, and no one else can per se join the pack, the SP may initiate a back and forth on-line negotiation between the SP and the supplier in an attempt to get the supplier to agree to an additional number of products committed to by consumers in the pack at the same or higher price, for example, to reopen the public pack 220.

Furthermore, when the pack 220 closes, the SP sends a purchase order (PO) 240 to the supplier (e.g., via email over the communication network 110) which includes the consumer information (name, shipping information, etc.). In accordance with an embodiment of the present invention, the PO 240 may include a service fee from the SP (e.g., a 4% fee or a 8% fee) for providing business to the supplier. In response to receiving the PO 240, the supplier sends shipments 250 of the products (e.g., the ten CXL24 cameras) to the various pack consumers in accordance with the information on the PO 240. Tracking numbers 260 are generated as part of the shipping process and the supplier sends the tracking numbers 260 of the shipments 250 to the consumers and the SP. The SP, upon receiving the tracking numbers 260, triggers the lifting of the hold on the customer credit cards and proceeds to charge the credit cards of the customers 270. The credit card companies pay the SP for the charged purchases and then proceed to provide a statement of the charges to the customers. The supplier does not have to deal with the credit card companies and any associated fees.

Furthermore, the supplier sends an invoice 280 to the SP for the shipped products and the SP makes a payment 290 to the supplier for the products. According to the invoice 280, the SP may have an invoiced period of time (e.g., 30 days, 60 days, 90 days) to pay the supplier. Once paid by the credit card companies, the SP may use the invoiced period of time to earn interest on the funds, for example, thereby enhancing the value of the pack 220 to the SP.

If a consumer wants to return the product after receiving the product, the consumer can send the product back to the supplier, and the supplier can refund the consumer. In such a scenario, the SP does not deal with returns and, therefore, does not suffer any financial loss due to a return.

In accordance with the examples of the invention as described, the invention is in an aspect directed to a method to buy and sell products wherein the consumer drives demand for a product. This allows the consumer to seek to buy products in the marketplace at a discounted price from retail. Some of these products may be the “hottest”, most popular, or trending products in the marketplace. The method comprises the consumer selecting at least one product that is not currently sold at a discounted price and creating a first non-public pack listing of at least one product at a particular price for a particular volume of units of the at least one product. In accordance with an embodiment, a consumer may create a non-public pack for a product or service by going to the SP server system website and entering a pack name, selecting a category, entering a preferred manufacturer, entering a description of the product or service (which may include one or more images), and entering a price the consumer is willing to pay. The consumer may also elect to be the pack leader.

At least one supplier commits to supply the at least one product at a particular price for a particular volume of units of the at least one product. This transforms the first non-public pack to a first public pack. At least one consumer then commits to buy the particular volume of the at least one product at the particular price to complete the sale of the at least one product to the at least one consumer. The method provides incentive for a supplier to sell larger quantities of a product at a discounted price. This is in contrast to the current situation where the supplier does not have incentive to discount the products. Product suppliers can use this sales avenue to control and move inventory effectively. The product supplier may even benefit by allowing consumers to drive trends in product categories, driving demand for their products. The invention gains the advantage of allowing consumers to seek and buy prime, new products in high demand, and at a discounted price, by offering volume discounting. The sales process is a “consumer driven” inquiry, allowing effective control by the consumer.

As an example, for a newly released video game that thousands or hundreds of thousands of gamers want to buy, being an example of product that is not currently sold at a discounted price at a retail level. Using the invention, gamers can create a public pack that other gamers can join to potentially allow the supplier to quickly sell a large number of games. This can similarly go for many other items, such as appliances, automotive, household goods, consumer electronics, or even cars or other bigger ticket items. The invention allows the consumer to drive sale of products that are not currently sold at a discounted price at a retail level. This type of product may also be characterized as products that have a shelf-life or the time period between offering it for sale at the retail level and sale of that product that is at or below a predetermined time period. For example, this type of product may be a product that has a shelf-life of one month (or other predetermined period). These types of products may also be characterized based on the date they are released for sale at the retail level, targeting the “newly released” products. For example, this type of product may be a product that has been sold at the retail level at a below a predetermined time period, such as six months (or other predetermined period).

In accordance with an embodiment, the SP may provide consumers with opportunities to purchase products and services from third party merchants with a time limited promotional added value (a deal). Merchants may be willing to offer attractive promotional deals to reach the SP consumer community. By placing an order for a deal, a consumer may make an offer to purchase the deal selected on the terms, restrictions, and conditions associated with the deal. Once an order is placed, the consumer receives a confirmation of the deal and the consumer's credit card is charged for the amount of the deal. The consumer will be notified by email when the voucher (discussed below) for the deal is ready to be used. The consumer may create an account to purchase a deal. The account is used to collect information to allow the consumer to pay for deals and to provide the consumer with easy access to print deals, view past purchases, and modify preferences.

In accordance with an embodiment, each deal combines two separate portions that make up the deal including a paid portion equal to the amount the consumer's credit card is charged and, at no additional charge to the consumer, a promotional portion for the balance of the value of the deal if used by the promotional expiration date on the voucher. Together, the paid and promotional portions of the deal are presented in a voucher. In the event the consumer redeems a voucher for less than the full amount stated on the voucher, the purchase will be allocated first against the paid portion until it has a balance of zero dollars, and then against the promotional portion that is remaining.

In accordance with an embodiment, if a service is requested, the pack of consumers that come together and ask for the service at a specific price may have to pay up front, and then will receive a voucher indicating that the service was purchased at a discount through the SP.

“Deal Bucks” are a form of SP currency that may be applied as a credit towards further purchases via the SP system. Deal bucks may be provided as rewards for pack creators and pack promoters bringing pack members into the pack through, for example, social networking outreach. Furthermore, deal bucks may be accumulated over time for loyal SP users. In accordance with an embodiment, there are three types of deal bucks including paid deal bucks, which may be purchased in certain incremental values (either as gift bucks or otherwise), earned deal bucks, which are awarded from time to time as loyalty rewards or as customer service deems appropriate, and promotional deal bucks, which are given to certain customers in connection with a specific promotion, contest, or sweepstakes. Promotional deal bucks expire in accordance with the terms of the particular promotion. Paid and earned deal bucks expire so many years after the date of purchase or issuance, except where expiration of paid deal bucks is prohibited by law. Paid deal bucks may be applied toward future SP purchases before earned deal bucks, even if the earned deal bucks expire first. Promotional deal bucks, however, may be applied first due to their short term. Additionally, all deal bucks may be applied towards purchases that are in the same currency as the earned, paid, or promotional deal bucks. Deal bucks may not be returnable or refundable for cash, except where required by law. Resale of deal bucks may be prohibited.

In summary, systems and methods for facilitating discounted volume purchasing of products are disclosed. A server system is configured to search the internet to discover product information about a product. The server system is further configured to generate a pack listing of product type, purchase quantity, and price per unit product based on the discovered product information, and to post the pack listing on a web site of the server system. The server system is also configured to facilitate the activation of the pack listing by a user of the web site to generate a non-public pack. The server system is further configured to facilitate the commitment of a supplier to the non-public pack, and the transformation of the non-public pack to a public pack. The server system is also configured to facilitate the filling of the public pack via the web site and various aspects of purchasing via the pack once the pack is filled by the requisite committed purchase quantity.

While the claimed subject matter of the present application has been described with reference to certain embodiments, it will be understood by those skilled in the art that various changes may be made and equivalents may be substituted without departing from the scope of the claimed subject matter. In addition, many modifications may be made to adapt a particular situation or material to the teachings of the claimed subject matter without departing from its scope. Therefore, it is intended that the claimed subject matter not be limited to the particular embodiment disclosed, but that the claimed subject matter will include all embodiments falling within the scope of the appended claims.

What is claimed is:

1. A method to facilitate purchasing of a product by at least one consumer, said method comprising:
creating a first non-public pack listing of at least one product at a particular price for a particular volume of units of the at least one product;
at least one supplier committing to supply the at least one product at the particular price for the particular volume of units of the at least one product;
transforming the first non-public pack to a first public pack;
at least one consumer then committing to buy the particular volume of the at least one product at the particular price to complete the sale of the at least one product to the at least one consumer as offered in the first public pack.

2. The method of claim 1, wherein the first non-public pack is created by at least one initiating consumer selecting the at least one product at a particular price for a particular volume of units of the at least one product.

3. The method of claim 1, wherein the at least one supplier is provided with information selected from the group consisting of product markets, consumer trends, price history, purchase trends, search trends and combinations thereof to facilitate deciding to commit to supply the at least one product at the particular price.

4. The method of claim 1, wherein a sale is effectively made at the time that the first public pack is successful in being completed, allowing for money from the sale to be available for a period before payment for the at least one product is made to the at least one seller.

5. The method of claim 1, wherein the offering of the at least one pack is for a particular period of time.

6. The method of claim 1, wherein the particular price is further discounted for the at least one public pack as the number of consumers and/or suppliers joining the at least one public pack increase.

7. The method of claim 1, wherein the creation of the first public pack triggers automatic communication via internet systems to the at least one consumer's contacts on such systems, indicating the creation of the first public pack.

8. The method of claim 1, further comprising offering the first non-public pack for a predetermined first period of time.

9. The method of claim 8, wherein if the first non-public pack doesn't get committed to by the at least one supplier within the first period of time, the first non-public pack is discontinued.

10. The method of claim 8, wherein the first non-public pack is created by at least one initiating consumer selecting the at least one product at a particular price for a particular volume of units of the at least one product, and if the first nonpublic pack doesn't get committed to by the at least one supplier within the first period of time, communications are made between the at least one supplier and/or at least one initiating consumer in an attempt to provide a second non-public pack.

11. The method of claim 7, wherein upon transformation of the first non-public pack to a first public pack, the first public pack is open to the at least one consumer to buy the at least one product for a predetermined second period of time.

12. The method of claim 1, further comprising providing incentive rewards to the at least one consumer that may be applied as a credit towards further purchases of products, selected from the group consisting of rewards for non-public pack creators, rewards non-public pack promoters, rewards for loyal consumers.

13. The method of claim 11, wherein the rewards may be purchased in certain incremental values, may be earned, or may be provided as promotional rewards.

14. The method of claim 1, wherein the at least one product selected by the at least one consumer is not generally currently sold at a discounted price at the retail level of product sales.

15. A method to facilitate discounted volume purchasing of a product, said method comprising:
a server system searching the internet to discover product information about a first product;
the server system generating a first pack listing of at least product type, purchase quantity, and price per unit product based on the discovered product information, and posting the first pack listing on a web site of said server system;
the server system facilitating the activation of said first pack listing by a first initiating user of the web site to generate a first non-public pack;
the server system facilitating the commitment of at least one supplier to the first non-public pack and the transformation of the first non-public pack to a first public pack; and
the server system facilitating the filling of the first public pack via the web site by at least one consumer.

16. A system to facilitate discounted volume purchasing of a product, said system comprising:
a server system searching the internet to discover product information about a first product;
the server system generating a first pack listing of at least product type, purchase quantity, and price per unit product based on the discovered product information, and posting the first pack listing on a web site of said server system;
the server system facilitating the activation of said first pack listing by a first initiating user of the web site to generate a first non-public pack;
the server system facilitating the commitment of at least one supplier to the first non-public pack and the transformation of the first non-public pack to a first public pack; and
the server system facilitating the filling of the first public pack via the web site.

17. The system of claim 16, wherein the server system uses at least one algorithm to define a plurality of predetermined terms of sale for the first pack listing for the first product from which the first user can select to generate the first non-public pack.

18. The system of claim 16, wherein the transformation of the first non-public pack to a first public pack triggers automatic communication via the internet to the at least one initiating user's contacts on the internet, indicating the creation of the public pack.

19. The system of claim 17, further comprising offering the first non-public pack for a predetermined first period of time.

20. The system of claim 19, wherein if the first non-public pack doesn't get committed to by the at least one supplier within the first period of time, the first non-public pack is either discontinued or communications are made between the at least one supplier and/or at least one initiating consumer in an attempt to provide a second non-public pack.
